(19) United States
(12) Patent Application Publication
(10) Pub. No.: US 2001/0004019 A1
(43) Pub. Date: Jun. 21, 2001

(54) Golf ball mark repair tool

(76) Inventor: James T. Wakefield, Palmdale, CA (US)

Correspondence Address: James T. Wakefield, 38908 Normandy CT, Palmdale, CA, 93551, US

(21) Appl. No.: 09/757,589

(22) Filed: Jan. 11, 2001

Related U.S. Application Data
(63) Continuation of application No. 09/189,998, filed on Nov. 12, 1998, now abandoned.

(51) Int. Cl. A01B 45/02

(52) U.S. Cl. 172/22; 172/21; 172/378; 172/375; 172/374; 473/408

(57) ABSTRACT

A hand held, manually operated excavation tool, which is specifically designed for single hand use to remove turf, which has been damaged by an air borne golf ball. The device has a handle, tubular shank, an internal ramp, an entry and an evacuation port, a concentric leading edge and an internal threaded portion to receive optional repair tools A threaded two-pronged aerator or culling tool may be stored in the handle portion. The principal object's shank is of sufficient length to penetrate, to an appropriate depth, turf which is commonly associated with that portion of a golf-course referred to as the “green.” The repair tool is designed to easily penetrate, core, capture and remove damaged, dying or dead turf. The efficient removal and subsequent repair of damaged portions of grass on a putting surface would improve the consistency of a putting green and the quality of play for all golfers on a given course. Furthermore, the device would assist golf course maintenance personnel in performing repair work more efficiently. The daily removal and immediate repair of damaged and dead grass from a green would allow golf course repair work to be performed in a site specific, more detail and continuous fashion.

### CROSS-REFERENCE TO RELATED APPLICATIONS

U.S. Ser. No. 09/189,998

### FED SPONSORED R & D

Not Applicable

### MICROFICHE APPENDIX

Not Applicable

### BACKGROUND OF INVENTION

1. Field of Invention

This invention relates to the excavation and coring of turf, but in particular to an apparatus that is specifically designed for use in the repair of golf greens damaged by golf balls during the course of golf practice and/or regular play. The principal object is intended for use commercially by section personnel and those persons, which are regularly assigned the duty of maintaining, caring for and grooming that portion of a golf course which is referred to as the “green.”

2. Description of the Prior Art

Several methods may be used to repair a golf ball mark on a putting green. They include, but are not limited to, the following: 1) using a miniature tine or fork to elevate and aerate a mark; 2) inserting and coring the damaged portion with a soil probe and removing grass, sand, soil and debris so that new seed and sand may be introduced into a fresh opening; and 3) using a manual or mechanized aerator with a series of tines to aerate the surface of a putting green after a large number of marks have accumulated.

In the United States of America, there are over 16,000 golf courses. A round of golf may be either nine or 18 holes. During play various clubs are used to advance a golf ball from the tee, where play begins, onto a fairway and then ultimately on to the green. A player tries to place his or her golf ball in a hole that is located within the boundaries of the green. The object of the game is to take the fewest strokes, or hits, at the golf ball, in order to put the ball in the hole.

After completing a shot to a green, the impact on the playing surface can cause the ball to create a deep depression or mark in the turf, The grass playing surface, at the point of impact, may die off with in 24 hours after being struck by a golfball. Normally, a golfer will effect instant repair to a mark using a two-pronged, forked-shaped tine. The most appropriate way to repair the mark is by insertion of the fork at the outer edge of the ball mark itself The fork should be placed in the portion of grass surrounding the mark that has not been affected. Then the fork should be moved toward the central portion of the damaged area, By so doing, healthy plant material will fill the point of impact and smooth out the overall playing surface. All too often, the central portion of grass at the point of impact, even after having been repaired, ultimately dies. Further, grass that is aerated during the repair process may become derooted, or the soil around the mark may recompress. When recompression occurs, it makes the playing surface uneven. The time it takes for damaged and dying grass to grow anew or to rejuvenate varies, but it is believed to be between seven to 14 days. A failure to immediately repair a golf ball mark properly has an adverse effect on the quality of play.

Commercial-grade turf repair and soil-coring devices are available to golf maintenance personnel for the purpose of ball-mark repair. Such devices are capable of repairing damaged grass or extracting dead plant material and soil. Once a portion of a green has been removed new sand, seed and soil are generally placed back in the cored area.

It is common practice for a golf course supervisor to order the mass repair of a significant number of golf ball marks in a singular effort. In such a case, a mechanized aerator is used on the entire surface of a green. A gang aerator is driven or towed over a green to perform the mechanized repair; it is generally undertake bi-annually, in the spring and fall. During the time that a green is being aerated, regular play is significantly interrupted. Often times, a green, which is undergoing repair, must be closed before, during and after the aeration process is fully completed.

The design, creation, installation and maintenance of a well-constructed golf-course green is a painstaking process. The specifications required by the United States Golf Association (USGA) for building a putting green is the result of years of academic and scientific research. According to the USGA, several thousand putting greens have been built according to their exacting standards. USGA guidelines include several steps. However, the primary emphasis is on resistance of a green to compaction and for proper drainage and run-off of surface water. The steps it takes to complete a USGA engineered green include, but are not limited to, the following: 1) The Subgrade; 2) Drainage; 3) Gravel and Coarse Sand Layers; 4) The Root Zone Mixture; 5) Top Mix Covering, Placement, Smoothing and Firming; and 6) Sterilization of Top Mix and Establishment of Turf. Clearly, there is considerable attention to detail in all phases of planning and construction of a USGA green. Once construction of a USGA green has been completed play on the “inks” may begin. After establishment of the greens has taken place, and play occurs on a regular basis, a comprehensive and systematic method of upkeep and repair must be implemented.

To better understand the exacting nature of golf course maintenance, let us examine a hypothetical situation involving a golf course. The course will be considered built to USGA greens specifications, and that 150 rounds of 18-hole golf are played there per day. The golf course is open for play six days a week, 50 weeks per year. The total number of rounds of golf played annually is 45,000. During the 45,000 rounds of 18-hole golf, there is a potential for 810,000 individual golf ball marks to be made on the cumulative green surfaces (18 greens×45,000 rounds of play per year=810,000). As the figure indicates, there is a high probability that each of the greens would have an extensive number of ball marks made on them throughout the year. Of concern to golf course superintendents are par three holes; they require the player to strike the ball in a lofty fashion from the tee. Generally, the ball is hit from the box on to the green in a single shot; and the shot is hit with a high arch. As a result a significant number of ball marks will be encountered on such a green. A standardized and systematic approach to the repair of each of the golf ball marks is required. Failure to properly manage ball mark repair in an ongoing fashion would certainly result in the rampant disfiguration, scaring and lumping on the surface of a green.

Equipment that is used to maintain courses has steadily evolved and improved over the years. Golf course playing surfaces have improved as well. New forms of grass are being used on golf course fairways collars and greens. As a direct result of the new generation grass, golf course maintenance practices have evolved and adapted to keep pace. An example of an improved grass is “Penn A-4 creeping bentgrass” (Agrostis palustris). Although Penn A-4 forms no part of the principal object, reference is drawn to it because of the nature of its improved growth patterns and texture. The improved characteristics of Penn A-4 relate directly to an increase in the quality of play that golfers, experience daily.

Dr. J. M. Duich of Penn State University developed Penn A-4. It has a significantly greater number of leaves per square decimeter than other forms of grasses that is now used on golf courses. Reports indicate that Penn A-4 grass has up to 2,200 plants per square decimeter. By way of comparison, a grass such as “Penncross” has some 900 plants per square decimeter. Penn A-4 grass has a significant pattern of vertical growth development, and leaf width.

Golf course superintendents, maintenance personnel and golfers themselves consider creeping Bentgrass to be a superior playing surface and quite possibly the most desirable form of grass for putting. In the game of golf, putting, strokes taken on a green with the club referred to as the “putter” accounts for a significant percentage of strokes, and ultimately affects a player's score and game. A green's texture, thickness, speed and other characteristics are extremely important. A well-maintained playing surface can make a round of golf much more enjoyable resulting in longer, straighter and more accurate putting. The increased density of grass such as Penn A-4 requires golf ball mark repair devices be capable of a quick and clean entry into the fuller, thicker turf. Any implement used to repair A-4 grass, or a plant material of similar quality must possess a significant level of utility.

A golf ball with a high trajectory, which lands on any portion of a green constructed to USGA standards, and that is covered with Penn A-4, would cause a significant ball mark. Said mark would require immediate attention and repair so as to preserve the integrity of the green. According to persons knowledgeable in the field of golf course maintenance, the most efficient method for repairing a ball mark for Penn A-4, is to manipulate the area around the site with one's fingers and thumbs. The depressed area is forced up toward the playing surface by applying pressure on all sides of the mark. By pressing, squeezing and lifting the area, one may gently bring the compacted soil and grass back to the surface. Afterwards, the affected area is smoothed out to ensure that the manipulated grass is level and consistent with the surrounding green. Although this form of repair is considered most appropriate for Penn A-4 grass, it is highly unlikely that a golfer and/or his or her caddie would perform the aforementioned labor intensive, manual procedure during the course of a four-hour, 18 hole round of golf.

As previously mentioned, the design and installation of a USGA green requires significant attention to detail. Care and maintenance of Penn A-4 grass requires a similar level of vigilance and oversight. The specifications for proper management of commercially used Penn A-4 require low fungicide. The application of pythium and dollar spot control and brown patch should be used only as needed. Although Penn A-4 was developed for the Southern regions, snow mold control may be required in areas of the North. Furthermore, excessive Nitrogen application should be avoided. Necessary top-dressing and brushing are done frequently so as to avoid puffiness and to ensure low mowing heights. The mowing height of Penn A-4 is maintained at ⅛″, or 3.2 mm to ensure its fine texture, upright growth patterns and density. The resultant benefits of proper care and management of Penn A-4 is a denser, finer textured and vertically upright putting surface.

Dr. Duich's development of an “A” and “G” series of grasses and similar research and development of hybrid plant material designed to be used as a golf course putting surface provide sufficient impetus for golf course superintendents and maintenance crews to “rethink” and to “retool” the devices they regularly use to repair and maintain public and private golf courses.

One may correctly assume that unless a golf ball is hit directly into a hole from either the fairway or tee, a player's golf ball will strike the green prior to entering the hole. It can be anticipated that a golfer's proper use of either an iron or wood, when striking a golf ball, will subsequently cause the airborne golf ball to impact the surface of a green and thus create a ball mark. Due to the significant number of golfball marks that are made on golf courses annually; and because grass types such as Penn A-4 require a precise and exacting regime of care to achieve optimal performance characteristics, the principal object has evolved. The principal object is intended for use in conjunction with various other types of probes, tines and aeration apparatus that are currently used for the purpose of golf course grooming and care.

### BRIEF SUMMARY OF THE INVENTION

The principal object is a manually operated, hand-held golf course repair tool. The device is specifically designed to repair the site of a golf ball mark on that portion of a golf course referred to as a green. The user holds, control and operate the principal object with a single hand. Using upper body and arm strength the device is inserted into turf. Dead or dying grasses, sand and soil are excavated from a putting green after being encased in the forward shank portion of the device. Once a cord piece of turf has been isolated in the device, it is removed from the playing surface. New sand is applied to the excavated site. Afterwards, the two-pronged fork, which is attached to the devices handle, is used to aerate the site and complete the repair process.

The principal object achieves the objectives of a more efficient and sanitary removal of cored grass, sand, soil, dying plant material and debris. Immediately after using the principal object to remove a damaged portion of a putting green, green ceramic silica sand or a similar substance may be easily administered into the excavated site. The principal object can isolate and remove damaged golf course grass from a green in a quick, user-friendly manner. The principal object is presented as a more appropriate means of golf ball mark repair than is currently manufactured and commercially utilized on public and private golf courses.

### BRIEF DESCRIPTION OF THE, DRAWINGS

FIG. 1 is a plain side view of the preferred embodiment of the principal object.

FIG. 2 is a side view of the principal object formed in accordance with the invention, the device's shank portion has been removed from the handle, exposing the two pronged fork and the handle storage compartment,

FIG. 3 is a side view of the principal object with dotted lines depicting the internal ramp and the location and manner in which the invention's internal fork is positioned.

### DETAILED DESCRIPTION OF THE INVENTION

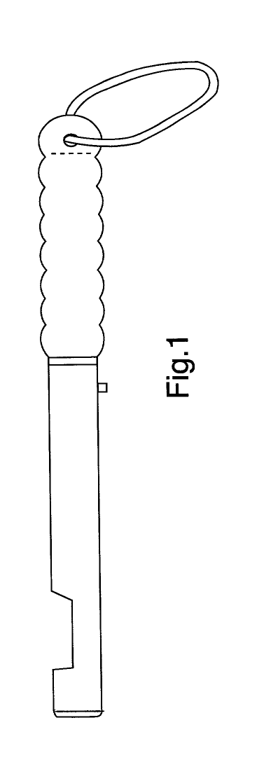

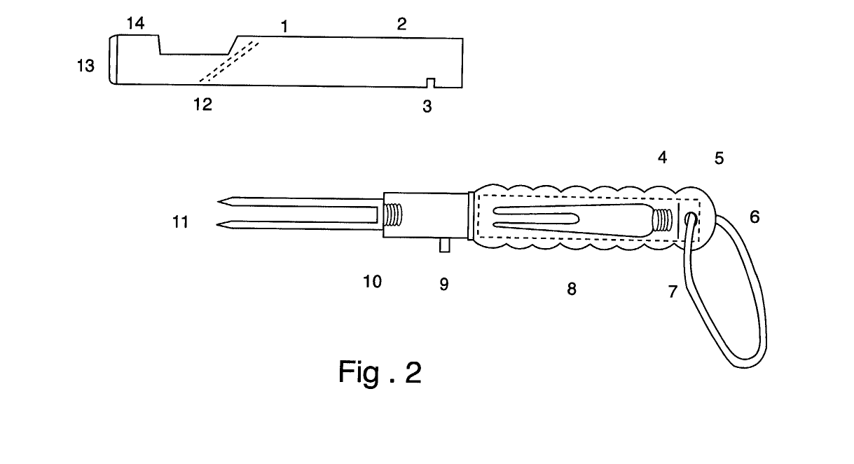

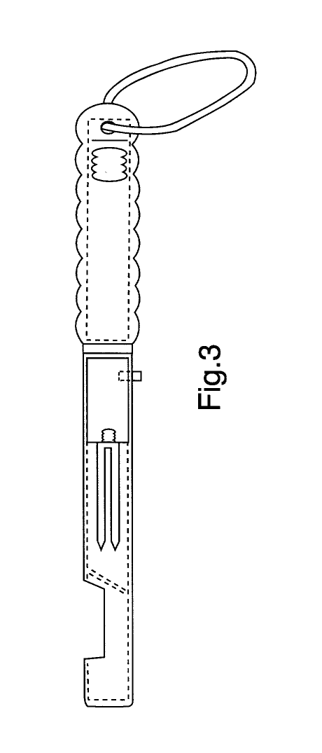

The accompanying drawings and FIG. 1, reveal the preferred embodiment of the principal object. FIG. 2, depicts the principal object 1, shank 2, spring button opening 3, handle 4, cap piece 5, grommet 6, handle storage opening 7, self-contained fork/aerator 8, spring release button 9, threaded receiver portion 10, threaded twin tine fork 11, internal ramp 12, forward leading lip 13, evacuation port 14. FIG. 3 shows the threaded two-pronged fork portion of the principal object affixed to the handle, within the shank. The materials that the principal object may be made from, in whole or in part, include, but are not limited to, the following: 1) metal, 2) wood, 3) plastic, 4) rubber, or 5) composite materials. The forward leading edge of the principal object may be manually inserted into a portion of turf that is proximate to the site of a golf ball mark. The damaged turf then travels reward to an evacuation ramp and evacuation port, where it is then placed in the appropriate trash receptacle. The shank maybe disengaged and removed by the user, The user depresses the spring-loaded button, located near the handle segment. The user may pull the shank forward and away from the handle exposing the repair fork. After green sand has been inducted into the cored portion of the green the two-pronged fork is used to press the turf toward the center of the cored segment. The device is specifically designed for one-handed use; it is placed over a golf ball mark which has damaged and/or dying grass within it. As previously mentioned the principal object is designed for thrusting directly into a playing surface. Downward pressure on the handle of the apparatus causes the concentric opening to pass into the earth to a point below the lowest level of surface damaged to turf. After inserting the device into the ground, the user would complete two one-half turns of the principal object. Turning once to the left and once to the right, would ensure that a complete 360-degree circle had been made around the ball mark. Grass, soil and sand are encased within the walls of the shank The area to be removed would then be separated from the remaining portion of turf on the green. The device is pulled up and away from the turf and playing surface. The upward movement causes the cored materials to separate from the playing surface. Dead, damaged and dying plant materials are then ready to be deposited in a refuse receptacle. A fresh mixture of green-colored ceramic silica sand and/or top-dressing is then poured into the newly cored hole. Top-dressing is dispensed into the cored opening and the two-pronged fork is used to aerate the area immediately outside the perimeter of the cored mark. Once the mark repair process has been completed, it may be repeated on various other portions of a putting green that have been similarly damaged.

The leading edge of the principal object is designed to facilitate penetration into grass and topsoil. The device's tubular opening is of sufficient size, to accept and trap turf. The shank allows plant material to freely move up the shank. Once the cored material has been collected in the tube, it remains there until such time as the material is either advanced further inside the shank or discarded from the evacuation port. In the case of repetitive and consecutive coring activities, each time the device is inserted into the soil it traps and advances additional material in the shank. With each successive insertion of the device into turf, the cored materials move further up the shank by way of the internal ramp. The trapped materials move along said ramp to ultimately be expelled via the port opening.

In the case of a single site, or single-use coring procedure, the encased material is immediately expelled from the apparatus. Expulsion in this case occurs by either thrusting or taping the forward lip at or into a refuse container. The cored material that is held in the shank is expelled via the ramp and evacuation port or the initial point of entry.

Since the preferential embodiment of the principal object has been duly described and depicted in detail, it should be clearly apparent, to anyone that is skilled in the art, that any number of physical modifications and/or changes may be made to the aforementioned invention without altering the invention's concept and principal nature. The principal object is to be considered in all aspects as illustrative and not restrictive. The full scope of the principal object is indicated by the appended claims. All changes and/or variations, which may come or that happen to fall within the scope, meaning and range of any and all equivalencies of the following claims, are to be embraced herein.

I claim:

1. A hand-held and manually operated combination excavator and aerator maintenance tool, which is designed to penetrate, core and remove turf, sand, or soil from that portion of an otherwise even-textured, well-groomed golf course which has been damaged by the forceful landing of a golf ball when said golf ball, having been previously set into play, is the proximate cause of the compression or pitting of a golf course green, comprising:
a tubular shank equipped with a handle grip portion at the terminal end and a concentric shaped excavator formed at the opposite or working end, said shank is elongated and of sufficient length to be thrust directly into turf or soil, said shank's leading or working end has a leading edge portion that has been fashioned to facilitate entry into the earth's crust, said portion is of sufficient diameter to receive and excavate damaged turf and subsoil that is similar in size to the diameter of a golf ball, the handle portion of the principal object has a threaded removable cap, which is capable of housing removable a threaded fork tine, or a threaded culling tool, said tools are for the specific purpose of aerating or removing turf and soil at the site of damaged turf.

2. The object according to claim 1 wherein the leading concentric edge has a forward projecting lip portion, the lip provides ease in penetrating grass, and the ground layer of soil or sand, said lip serves as the foremost contact point of the leading edge of the principal object with material, which is intended to be cored and subsequently confined within the tubular chamber portion of the shank.

3. The object according to claim 1 wherein an elliptic-shaped opening is formed in the wall of the shank, said opening is situated between the leading edge and handle, said opening serves as an evacuation port for cored material, which has been has been temporarily collected after passing through the leading edge of the shank and passes within the inner wall of said shank.

4. The object according to claim 1 wherein a diagonal ramp is fashioned at 45-degrees within the shank, said ramp extends diagonally from a position of the shank's interior wall proximate to the leading concentric edge to a terminal part on the shank's interior wall adjacent to that portion of the evacuation port which is proximate to the handle, the diagonal ramp facilitates movement of excavated material out of the shank portion of the device after coring.

5. The object according to claim 1 wherein a two pronged, threaded and removable turf and subsoil aerator may be housed within the tubular shank, said aerator maybe accessed by depressing a spring loaded button, said release is permanently affixed to the handle portion of the principal object, the pressure activated button allows the user to disengaged the shank from the handle portion exposing the threaded two pronged tine, said tines are slender and long, having a fixed point at each of their terminal parts, the tines facilitate penetration of the area immediately about a depression in grass or soil so as to decompress, open up and elevate the compacted turf or soil.

6. The object according to claim 1 wherein the handle has a threaded receiver portion in one segment and a removable cap piece at the terminal portion, said cap piece has a single hole opening located in it, said opening accommodates a grommet attachment so that the user may retain control of the device about the users wrist, a portion of the handle is hollowed out to allow for the storage of additional threaded accessories in reserve.
